(19) United States
(12) Patent Application Publication
(10) Pub. No.: US 2006/0143190 A1
(43) Pub. Date: Jun. 29, 2006

(54) Handling of digital silence in audio fingerprinting

(76) Inventors: Jaap Andre Haitsma, Eindhoven (NL); Johan Cornelis Talstra, Eindhoven (NL); Antonius Adriaan Maria Staring, Eindhoven (NL); Antonius Adrianus Cornelis Maria Kalker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,398

(22) PCT Filed: Feb. 18, 2004
(86) PCT No.: PCT/IB04/50120

§ 371 Date: Aug. 18, 2005

(30) Foreign Application Priority Data
Feb. 26, 2003 (EP) 03100461.7-

(51) Int. Cl. G06F 7/00; G06F 17/00

(52) U.S. Cl. 707/100

(57) ABSTRACT

The invention relates to a method, a device, a client-server system as well as a computer program product and computer program element for handling digital silence when fingerprinting digital media signals. A fingerprint comprising a number of sub-fingerprints for at least a part of the digital media signal is generated, (step 42), and the influence of at least one piece of the media signal on the fingerprint is removed or changed, (step 48), which piece corresponds to digital silence. The invention in a reliable way avoids a wrong identification of media signals, such as audio signals, where digital silence is included. The invention is also easy to implement by only requiring some of the functionalities already provided in a computer.

### TECHNICAL FIELD

The present invention generally relates to the field of fingerprinting of digital media signals, such as audio and more particularly to the generation of fingerprints when a part of the digital media signal includes digital silence.

### DESCRIPTION OF RELATED ART

It is known to provide fingerprints for media signals such as audio signals in order to identify a certain piece of music. A local computer then generates a fingerprint for an audio signal and sends this fingerprint as a query to a database. In the database the fingerprint is compared with other fingerprints and if a match is found, it is returned to the local computer, which then has received an identification of the audio signal.

Such fingerprinting is useful in many applications, for instance in radio stations for identifying play lists, but there is also a growing market for private persons wanting to buy music after having identified it, for instance on the radio.

One such fingerprinting scheme is described in “A Highly Robust Audio Fingerprinting System”, by Jaap Haitsma and Ton Kalker, Ismir, October 2002, where fingerprints are made up by a number of sub-fingerprints. A sub-fingerprint is based on a part of the media signal. 256 consecutive sub-fingerprints, which we will refer to as the fingerprint or fingerprint block, are computed during a short time interval in order to provide a fast and safe identification of the media signal. A fingerprint can therefore be taken on for example the first three seconds of a media signal. A positive identification is made in a fingerprint database based if the Hamming distance between the derived fingerprint and a fingerprint in the database is below a certain threshold.

A problem of the known fingerprinting schemes that often the media signal can have parts that are made up of digital silence. An audio clip might for instance start with silence, where for instance the PCM sample has a value of zero, and a video clip can start with a number of black frames. This means that sub-fingerprints made in the beginning during this digital silence, will be identical and reflect that no information is present. Since a lot of different media signals or files can have this digital silence in the beginning, it is possible that a query with a fingerprint made on the beginning would be found to wrongly correspond to several different stored media signals in the database.

### SUMMARY OF THE INVENTION

It is thus an object of the present invention to provide fingerprinting where the effects of digital silence in a media signal are removed such that fingerprinting can be used with a diminished risk of identifying the wrong media signal.

According to a first aspect of the present invention, this object is achieved by a method of handling digital silence when fingerprinting a digital media signal comprising the steps of:

generating a fingerprint comprising a number of sub-fingerprints for at least a part of the digital media signal, and

removing or changing the influence of at least one piece of the media signal on the fingerprint, which piece corresponds to digital silence.

According to a second aspect of the present invention, this object is also achieved by a device for handling digital silence when fingerprinting digital media signals and comprising:

a fingerprint generating unit arranged to generate a fingerprint comprising a number of sub-fingerprints for at least parts of a digital media signal, and

a digital silence removal unit arranged to remove or change the influence of at least one piece of the media signal on the fingerprint, which piece corresponds to digital silence.

According to a third aspect of the present invention, this object is furthermore achieved by a system of devices for handling digital silence when fingerprinting digital media signals and comprising:

a server device having a database of fingerprints related to media signals stored as media files, and

a client device for generating fingerprint queries to the server device, wherein at least one of client and server device comprises:

a fingerprint generating unit arranged to generate a number of sub-fingerprints for at least parts of a digital media signal, and

a silence removal unit arranged to remove or change the influence of at least one piece of the media signal on the fingerprinting, which piece corresponds to digital silence.

According to a fourth aspect of the present invention, this object is also achieved by a computer program product for handling digital silence when fingerprinting digital media signals, to be used on a computer, comprising a computer readable medium having thereon:

computer program code means, to make thy computer execute, when said program is loaded in the computer:

generate a number of sub-fingerprints for at least parts of a digital media signal, and

remove or change the influence of at least one piece of the media signal on the fingerprint, which piece corresponds to digital silence.

According to a fifth aspect of the present invention, this object is also achieved by a computer program element for handling digital silence when fingerprinting digital media signals, to be used on a computer, said computer program element comprising: computer program code means, to make the computer execute, when said program is loaded in the computer:

generate a number of sub-fmgerprints for at least parts of a digital media signal, and

remove or change the influence of at least one piece of the media signal on the fingerprint, which piece corresponds to digital silence.

Claims 2 and 3 are directed towards removing the cause for digital silence.

Claim 4 is directed towards adding random values to the whole media signal.

Claims 5 and 16 are directed towards providing random values for changing the influence of digital silence.

Claims 6 and 17 are directed towards replacing sub-fingerprints representing digital silence with random values.

Claims 7 and 18 are directed towards replacing samples of the media signal representing digital silence with random values.

Claim 8 is directed towards providing different types of random number generations in a client and a server device.

Claims 10 and 19 are directed towards processing the random number with time and date information related to the generation of a fingerprint for lowering the probability of false identifications of media signals.

The present invention has the advantage of in a reliable way avoiding a wrong identification of media signals in which digital silence is included. It is also easy to implement by only requiring some of the functionalities already provided in a computer. In a variation of the invention it also guarantees that random numbers generated almost certainly do not generate false identifications.

The general idea behind the invention is thus to remove digital silence related to media signals or to replace it with random values when generating fingerprints for the media signal.

The expression digital silence is intended to comprise digital audio signals where the information in the signal represents no sound or sound below a certain low threshold where different valued sub-fingerprints are not possible to generate as well as digital video information where the information in the frames represents black or is below a certain threshold in which no images are discernible.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIG. 1 shows a block schematic of a device for generating fingerprints together with a database of fingerprints,

FIG. 2 schematically shows a client device connected to a server device via a network

FIG. 3 shows a block schematic of a device for handling digital silence according to the invention,

FIG. 4 shows a flow chart of a method of handling digital silence according to a first embodiment of the invention,

FIG. 5 shows a flow chart of a method of handling digital silence according to a second embodiment of the invention,

FIG. 6 shows a block schematic of a first variation of a random number generating unit in the device in FIG. 3,

FIG. 7 shows a second variation of a random number generating unit for a device for handling digital silence according to the invention, and

FIG. 8 shows an optical disc on which program code for performing the invention is stored.

### DETAILED DESCRIPTION OF EMBODIMENTS

The present invention relates to the field of providing fingerprints for digital media signals and will in the following be described in relation to fingerprinting of audio signals. It is however not limited to audio but can be applied for other media signals like for instance video.

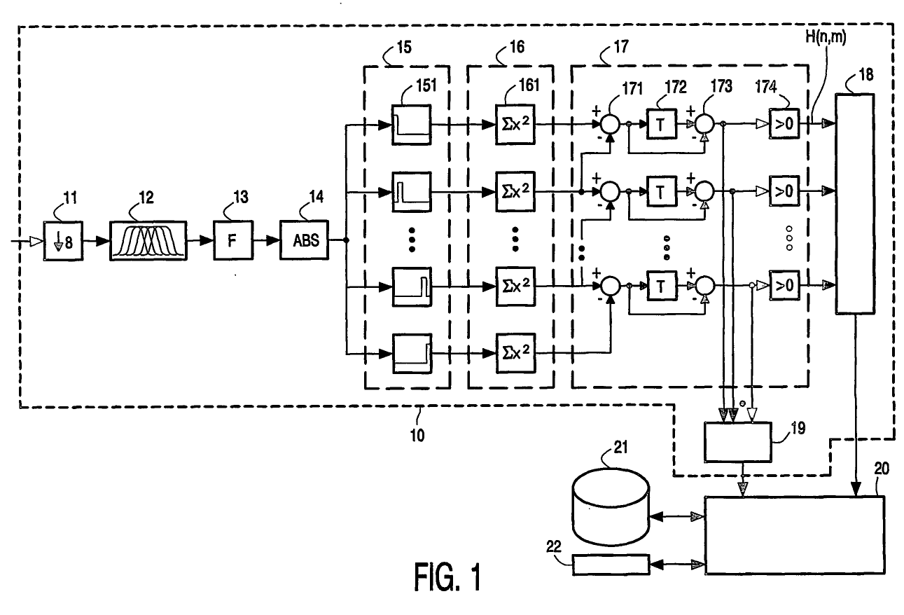

FIG. 1 shows a block schematic of a fingerprinting device 10 or fingerprint generating unit connected to a database 21 and arranged to generate sub-fingerprints based on an audio signal. The fingerprinting device 10 in FIG. 1 is intended to be provided in a client device which can communicate with a server, which includes the database. A client can contact this database in order to identify an audio signal via a fingerprint. In order to generate a fingerprint, the fingerprinting device 10 receives an audio signal at a downsampler 11, which downsamples the audio signal. The downsampled audio signal is then forwarded from the downsampler to a framing circuit 12, which divides the audio signal into (preferably overlapping) frames, which are weighted by a Hanning window. The thus framed audio signal is then forwarded to a Fourier transform circuit 13, which computes spectral representations of every frame. In a following block 14, absolute values of the Fourier coefficients are calculated. The device also includes a band division stage 15, which divides the frequency spectrum into a number of bands and includes a number of selectors 151, which selects the Fourier coefficients of the respective band. To this band division stage 15 is connected an energy computing stage 16, which has a stage 161 for each band. The stage 16 computes the energy of the magnitudes of the Fourier coefficients of the respective bands. A bit derivation circuit 17 is connected to the energy computing stage 16. The bit derivation circuit 17 converts the energy levels of each band into bits and is for this purpose provided with a first subtractor 171, a frame delay 172, a second subtractor 173 and a comparator 174 for each band. The resulting sub-fingerprints of all successive frames are stored in a buffer 18 as a fingerprint. The fingerprinting device also includes a bit reliability determining circuit 19, which determines the reliability of the bits in the fingerprint. The fingerprint in the buffer 18 and the bit reliability information from the bit reliability determining circuit 19 are sent from the device 10 to a computer 20 provided in the server. The database 21 connected to the computer 20 has a number of stored fingerprints all comprising sub-fmgerprints for a large number of audio signals or songs. In FIG. 1 there is also shown a look-up table 22 and, which the computer 20 uses when searching for a matching fingerprint in the database 21, which matching fingerprint corresponds to a fingerprint received from the device 10.

One difference between the fingerprints in client and server is that the database includes fingerprints for whole audio signals, whereas a client normally only generates one or a few fingerprints for an audio signal. The functioning of the device shown in FIG. 1 and the generation of fingerprints as well as how matching of fingerprints is being performed is described in more detail in the document “A Highly Robust Audio Fingerprinting System”, by Jaap Haitsma and Ton Kalker, Ismir, October 2002, which is herein incorporated by reference.

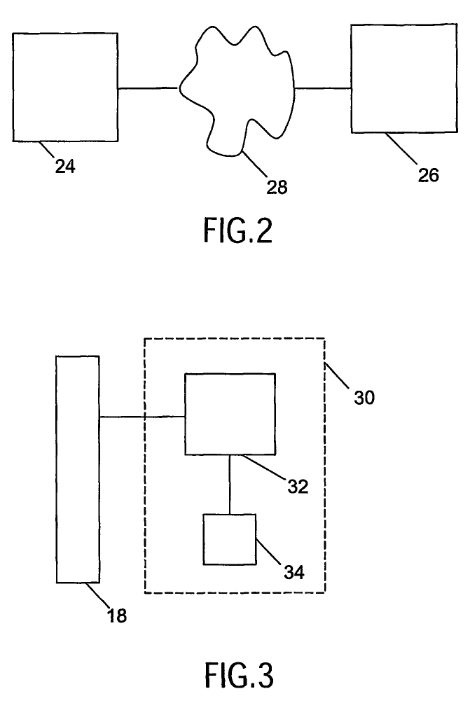

FIG. 2 shows a client device 24 connected to a server device 26 via a computer network 28, like the Internet. The client device 24 thus generates a fingerprint generated in the above-described way and sends this together with bit-reliability information as a query to the server 26 for audio signals in need of identification. The server 26 looks in the database and returns information about the audio signal to the client after searching in the database. The returned information is normally metadata like name of song, artist etc. When doing this identification the server compares the sub-fingerprints in a fingerprint with the sub-fingerprints of audio signals stored in the database and returns a positive identification, when the Hamming distance between two fingerprints are found to be below a certain threshold.

In the device described above identification of a piece of audio can be made quickly based on a fingerprint corresponding to approximately 3 seconds and containing 256 sub-fingerprints. This can however lead to some problems, which this invention will solve. Many audio signals or clips may start with silence, which can be a few seconds long. Many audio signals will therefore include information, which actually represents silence. This means that there can be several audio signals all of which are also started with silence that can be found to correspond to an audio file for which a fingerprint is taken. There is thus a need for taking care of this silence. In case of video this would correspond to a number of black frames at the beginning.

A device for handling digital silence 30 according to the invention is shown in a block schematic in FIG. 3. The device 30 includes a control unit 32 arranged to be connected to the buffer 18 of the fingerprinting device shown in FIG. 1 and a random number generating unit 34 connected to the control unit 30.

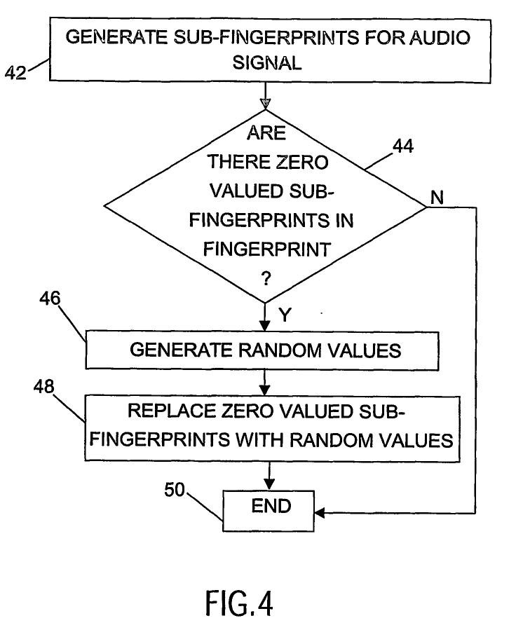

The functioning of the units in FIG. 3 will now be described for use in a client device together with FIG. 4, which shows a flow chart of a first embodiment of a method according to the invention. The client device first generates a number of subfingerprints for an audio signal in a fingerprinting device, step 42, which sub-fingerprints are stored in the register 18. The control unit 32 of the device 30 fetches these sub-fingerprints from the register 18 and investigates if any of these sub-fingerprints have zero values, i.e., correspond to digital silence in case of the described fingerprinting algorithm, step 44. If not any of them do, the sub-fmgerprints are kept unchanged in the register and then the investigation is ended, step 50. If they do include zero values, the control unit 32 contacts the random number generating unit 34, which generates random values, step 46. These random values are then submitted to the control unit 32, which replaces the zero valued sub-fingerprints with these random values in the sub-fingerprint register 18, whereupon the investigation is ended, step 50. When the client device later sends a query including a fingerprint where zero valued sub-fingerprints have been replaced by these random values to the server, the probability of finding a match in the database is very low, which avoids the return of a wrong match of the audio signal. If the client device has to make a positive identification it has to send another query later, when the audio signal is not silent, and then a positive identification can be made.

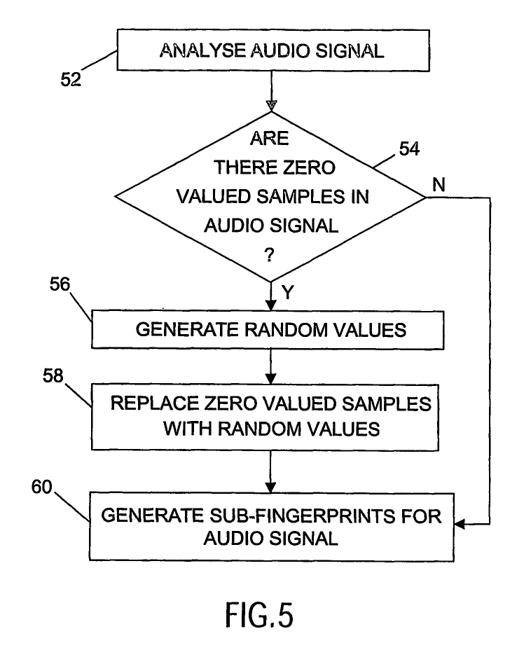

The device 30 can as an alternative be provided on the input side of the client device, i.e. before sub-fingerprints are generated. In this case the control unit 32 will be connected to a register where the actual audio signal is temporarily stored before being subject to fingerprinting. A method according to an alternative embodiment of the invention will now be described with reference being made to FIG. 5, showing a flow chart of a method according to this second embodiment. First the samples of the audio signal, which can consist of a number of PCM samples, are analysed by the control unit, step 52, for determining if there are any zero samples present or rather if there are samples that are beneath a certain lowest level, which would result in a sub-fingerprint of zero, step 54. If there are, the random number generator is made to generate random numbers, step 56. Thereafter the control unit 32 replaces the zero valued PCM samples or rather the samples under said threshold with the random values, step 58. Thereafter the samples of the audio signal are submitted to the fingerprinting device for generation of sub-fingerprints in the known way, step 60. Since the zero level samples of the audio signal have already been replaced, the sub-fingerprints subsequently generated for theses samples will likewise be random in nature and therefore a match for silent parts of the audio signal in the database is less likely. In case there are no zero values samples, step 54, fingerprinting generation is performed directly, step 60.

There are some other possible variations to the above-described scheme. One variation of the alternative embodiment of the invention is to add a small piece of random noise to all samples of the audio signal before a fingerprint is generated, i.e. also to the samples not corresponding to silence. It is furthermore possible to remove the digital silence from either the digital samples before fingerprinting is performed or to remove the sub-fingerprints, which correspond to digital silence instead of replacing them with random numbers. When this is done it is however not guaranteed that the spacing between subsequent sub-fingerprints are 11,8 ms apart. Then there is a risk that low-amplitude noise which can be added to a radio broadcast audio signal instead of silence will be a part of the fingerprint sent to a database. If the database has the corresponding silence removed, this will lead to a less than optimal match.

The unit in FIG. 3 can just as well be provided together with a fingerprinting device in the server as in the client, either before the fingerprinting device or after, as was described above. This ensures that the database will not have any sub-fingerprints having a zero value for a fingerprint of a piece of audio, but these are replaced by random words. Digital silence can also be removed in the server in the same way as was described in the paragraph above, by removing the digital silence samples or the sub-fingerprints corresponding to digital silence.

The sub-fingerprints generated are of 32 bits and a sub-fingerprints corresponding to silence is then the hexadecimal value 0x00000000. It is convenient to use a standard linear congruential random number generator for generating 32 bit random words to use for replacing the zero sub-fingerprints. The random number generator is initialised with a random number X₀. Subsequent random numbers are obtained according to equation (1) below.
X_{N+1}=(1664525*X_{N +}1013904223)mod 2³² (1)

There is however a problem with the use of this method in case both the client and the server have fingerprints where this same type of random number generator has been used. Since the only real random number is the first number and all subsequent random numbers are computed in a known way from this first random number, there is a risk that both the devices will end up with the same random numbers for digital silence. This could lead to a matching of the fingerprint in the database based on the sequence of “random” sub-fingerprints for silence. If the database has about 1 million songs this risk is at least 1/4000 or 0,025%. In fact the risk is even higher than this because of the risk of matching between sub-fingerprints in a query and database provided in different positions in the fingerprint

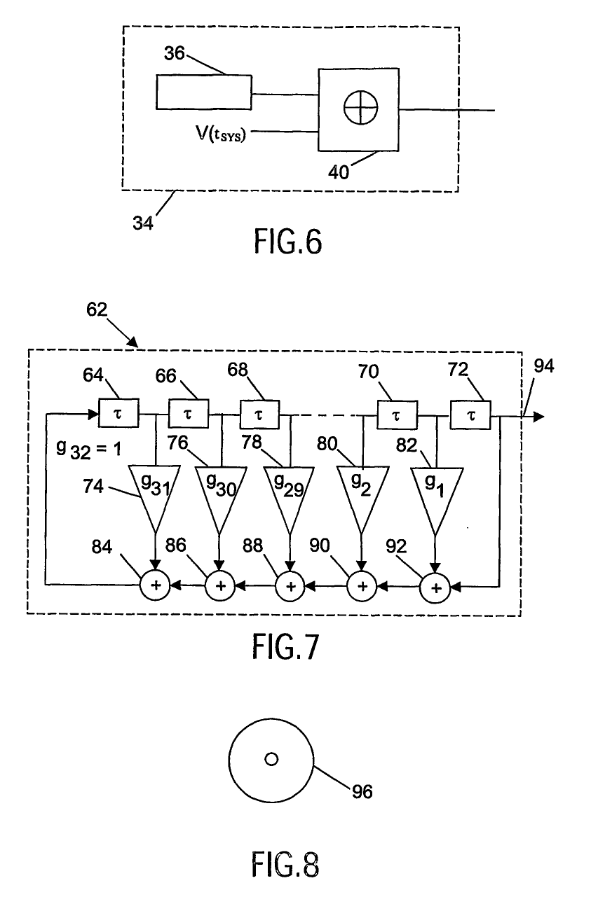

One way to solve this problem is to have different random number generating schemes for client and server. This would lead to different implementations of database and fingerprint query generation in server and client. Another solution to this problem will be described in relation to FIG. 6 below.

FIG. 6 shows a first variation of a random generating unit 34, which includes a standard linear congruential random number generator 36 connected to a first input of a logical unit 40, which in this case is a logical Exclusive-OR unit 40. The logical unit 40 receives a value V(t_{sys}) on a second input, which value is a 32-bit value that is dependent on the date and time of the generation of the fingerprint. The value V(t_{sys}) is dependent on the system time of the computer where the random number generator is provided. This makes the subsequent random values not only dependent on the first random value but also on the current system time and date.

The probability for these values to correspond to digital silence in both the client and the server are therefore reduced significantly.

One variation of this latter unit is shown in FIG. 7. FIG. 7 shows a Linear Feedback Shift Register circuit 62 which is used for generation of random bits. The unit includes a number of tapped delay lines τ, 64-72. The delays are connected in series and the last 72 is connected to the output 94 of the random number generating unit 62. A multiplying unit _{g1}82, _{g2}84, . . . _{g29}78, _{g3o}76 and _{g31}74 is provided between each delay unit. The multiplication factor can be either 1 or 0. Each multiplying unit is connected to a corresponding adding unit 84-92, of which a last 92 is also connected directly to the output 94 and a first 84 is connected to the input of the first delay unit 64. In order to produce 32 m bit random numbers one needs 32 of these Linear Feedback Registers. Each of the 32 LFSR's is initialised with a different 32-bit number derived from the computer system time. Every LSFR generates 1 random bit. Since every LFSR is initialised with a 32 bit number that depends on the system time, the cycle of this implementation also depends on the system time.

The present invention is preferably provided with one or more processors with associated program memory in which the program code for performing the method according to the invention is stored. The program code can also be provided in the form of a data carrier, like a CD Rom disk 96 as is shown in FIG. 8. The program code can also be downloaded to a device from a server via a network, like the one shown in FIG. 2.

The present invention has several advantages. It avoids the wrong identification of media signals in which digital silence is included in a reliable way. It is also easy to implement since it uses some of the functionality already provided in a computer. In a variation of the invention it also guarantees that random numbers generated almost certainly do not generate false identifications.

The present invention has been described in relation to computers in a computer system. However, it is not limited to this, but can be implemented in other types of environments for instance like in a mobile phone communicating with a server via a cellular network. A mobile phone can also be made to communicate with a computer that is a client device connecting to a server including the above-mentioned database. The invention is furthermore not limited to the described fingerprinting scheme, but can be implemented in any fingerprinting scheme that has to be capable to handle digital silence. The invention was described in relation to PCM samples. It should be realised that it is also applicable when different types of compression and coding are used, like MP3-coding as well as for other types of media signals like video Therefore the present invention is only to be limited by the following claims.

In summary, the invention relates to a method, a device, a client-server system as well as a computer program product and computer program element for handling digital silence when fingerprinting digital media signals. A fingerprint comprising a number of sub-fingerprints for at least a part of the digital media signal is generated, (step 42), and the influence of at least one piece of the media signal on the fingerprint is removed or changed, (step 48), which piece corresponds to digital silence. The invention in a reliable way avoids a wrong identification of media signals, such as audio signals, where digital silence is included. The invention is also easy to implement by only requiring some of the functionalities already provided in a computer.

1. Method of handling digital silence when fingerprinting a digital media signal comprising the steps of:
generating a fingerprint comprising a number of sub-fingerprints for at least a part of the digital media signal, (step 42; 60) and
removing or changing the influence of at least one piece of the media signal on the fingerprint, (step 48; 58), which piece corresponds to digital silence.

2. Method according to claim 1, wherein the step of removing or changing the influence comprises removing the piece of the digital media signal before generating a fingerprint.

3. Method according to claim 1, wherein the step of removing or changing the influence comprises removing a sub-fingerprints from the fingerprint having a value corresponding to digital silence of said piece of the media signal.

4. Method according to claim 1, wherein the step of removing or changing the influence comprises providing a random value for said piece of the media signal corresponding to digital silence.

5. Method according to claim 4, wherein the step of providing a random value comprises adding a random value to each piece of the media signal.

6. Method according to claim 4, wherein the step of providing a random value comprises substituting a sub-fingerprint having a value corresponding to digital silence in the media signal with a random value, (step 48).

7. Method according to claim 4, wherein the step of providing a random value comprises substituting a piece of the media signal corresponding to digital silence with a piece corresponding to random noise before starting generation of a fingerprint, (step 58).

8. Method according to claim 4, wherein the method is performed in a first device (24) and the way random values are generated in the first device differs from the way random values are generated in a second device (26), with which the first device is communicating in order to identify a media signal.

9. Method according to claim 4, wherein the step of providing a random value comprises generating a random value using a random number generator.

10. Method according to claim 9, further including the step of processing the random value with additional information that is dependent on time and date information related to the generation of the fingerprint.

11. Method according to claim 10, wherein the step of processing comprises performing and exclusive-or operation on the random value and the additional information.

12. Method according to claim 10, wherein the processing is provided through a number of linear feedback shift registers.

13. Method according to claim 1 further including the step of transferring the fingerprint to a server for matching against a fingerprint database.

14. Method according to claim 1, further including the step of storing the fingerprint in a server fingerprint database to be used for matching against fingerprints received from client devices.

15. Device (24; 26) for handling digital silence when fingerprinting digital media signals and comprising:
a fingerprint generating unit (10) arranged to generate a fingerprint comprising a number of sub-fingerprints for at least parts of a digital media signal, and
a digital silence removal unit (30) arranged to remove or change the influence of at least one piece of the media signal on the fingerprint, which piece corresponds to digital silence.

16. Device according to claim 15, wherein the silence removal unit (30) includes a random number generating unit (34; 62) for generating a random value for the piece of the media signal corresponding to digital silence.

17. Device according to claim 16, wherein the silence removal unit (30) is arranged to substitute a sub-fingerprint generated by the fingerprint generating unit having a value corresponding to digital silence in the media signal with a random value.

18. Device according to claim 16, wherein the silence removal unit (30) is arranged to substitute the piece of the media signal corresponding to digital silence with a piece corresponding to random noise before submission to the fingerprint generating unit for generating a fingerprint.

19. Device according to claim 16, further including a logical function unit (40) arranged to process the random value with additional information that is dependent on time and date information related to the generation of the fingerprint.

20. Device according to claim 19, wherein the logical function unit (40) is an exclusive-or unit.

21. Device according to claim 16, wherein the random number generating unit (62) is provided as a number of linear feedback shift registers.

22. Device according to claim 15, wherein the device is a client device (24) arranged to generate fingerprint queries to a server device (26) including a database (21) of fingerprints for a number of different media signals.

23. Device according to claim 15, wherein the device is provided in a server (26) including a database (21) of fingerprints for a number of different media signals used for communication with at least one client device (20).

24. System of devices for handling digital silence when fingerprinting digital media signals and comprising:
a server (26) device having a database (21) of fingerprints related to media signals stored as media files, and
a client device (24) for generating fingerprint queries to the server device, wherein at least one of client and server device comprises:
a fingerprint generating unit (10) arranged to generate a number of sub fingerprints for at least parts of a digital media signal, and
a silence removal unit (30) arranged to remove or change the influence of at least one piece of the media signal on the fingerprinting, which piece corresponds to digital silence.

25. Computer program product for handling digital silence when fingerprinting digital media signals, to be used on a computer, comprising a computer readable medium (96) having thereon computer program code means, to make the computer execute, when said program is loaded in the computer:
generate a number of sub-fingerprint for at least parts of a digital media signal, and
remove or change the influence of at least one piece of the media signal on the fingerprint, which piece corresponds to digital silence.

26. Computer program element for handling digital silence when fingerprinting digital media signals, to be used on a computer, said computer program element comprising computer program code means, to make the computer execute, when said program is loaded in the computer:
generate a number of sub-fingerprints for at least parts of a digital media signal, and
remove or change the influence of at least one piece of the media signal on the fingerprint, which piece corresponds to digital silence.
